(19) United States
(12) Patent Application Publication
(10) Pub. No.: US 2025/0224719 A1
(43) Pub. Date: Jul. 10, 2025

(54) METHOD AND APPARATUS WITH FAILURE PREDICTION AND DETECTION

(71) Applicant: SAMSUNG ELECTRONICS CO., LTD., Suwon-si (KR)

(72) Inventors: Byungwoo BANG, Suwon-si (KR); Uiseok SONG, Suwon-si (KR); Junyeon LEE, Suwon-si (KR); Wooseok CHANG, Suwon-si (KR); Hun Seong CHOI, Suwon-si (KR)

(73) Assignee: SAMSUNG ELECTRONICS CO., LTD., Suwon-si (KR)

(21) Appl. No.: 18/894,765

(22) Filed: Sep. 24, 2024

(30) Foreign Application Priority Data
Jan. 4, 2024 (KR) 10-2024-0001714

(51) Int. Cl. G05B 23/02

(52) U.S. Cl. CPC G05B 23/024; G05B 23/0283

(57) ABSTRACT

A computing device including processors configured to execute instructions and a memory storing the instructions, an execution of the instructions configures the processors to collect sensor data about components included in the computing device while the computing device is processing an allocated process, receive the sensor data about the components from the BMC and predict a failure occurrence one or more components among the components based on the sensor data about the components, and receive the sensor data about the components from the BMC and detect whether a failure has occurred for the one or more components among the components based on the sensor data about the components.

### CROSS-REFERENCE TO RELATED APPLICATIONS

This application claims the benefit under 35 USC § 119 (a) of Korean Patent Application No. 10-2024-0001714, filed on Jan. 4, 2024, in the Korean Intellectual Property Office, the entire disclosure of which is incorporated herein by reference for all purposes.

### BACKGROUND

### 1. Field

The following description relates to a method and apparatus with failure prediction and detection.

### 2. Description of Related Art

Unlike computing devices used by general consumers and users, typical computing devices intended for data centers and high performance computing (HPC) may require high stability. In an effort to achieve high stability, computing devices for data centers and HPC may be typically equipped with extra power supplies and fans. In addition, these higher performing computing devices may typically monitor for failures through various sensors arranged in various locations within the computing devices.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a computing device including processors configured to execute instructions and a memory storing the instructions, an execution of the instructions configures the processors to collect sensor data about components included in the computing device while the computing device is processing an allocated process, receive the sensor data about the components from the BMC and predict a failure occurrence one or more components among the components based on the sensor data about the components, and receive the sensor data about the components from the BMC and detect whether a failure has occurred for the one or more components among the components based on the sensor data about the components.

The receiving the sensor data may include executing a prediction model though a neural processing unit (NPU) for predicting a failure for the one or more components using the sensor data about the components as input.

The receiving the sensor data may include detecting a failure though a neural processing unit (NPU) for the one or more components using the sensor data about the components as input.

The processors may be configured to transmit a prediction result of the failure occurrence for the one or more components to an external scheduler of the computing device or for internal scheduling by the processors and the external scheduler of the computing device or the internal scheduling may be configured to determine whether to migrate a process being processed by the computing device based on the prediction result of the failure occurrence for the one or more components.

The external scheduler of the computing device may be configured to determine whether to migrate the process being processed by the computing device to another computing device.

The receiving the sensor data may include outputting a failure grade indicating severity of a failure, a probability of occurrence of a failure, and time at which a failure occurs, as a prediction result of the failure occurrence for the one or more components.

The processors may be configured to transmit a detection result of the failure occurrence for the one or more components among the components to an external scheduler of the computing device or for internal scheduling by the processors and the external scheduler of the computing device or the internal scheduling may be configured to restore or restart a process being processed, to a previous checkpoint, by the processors.

In a general aspect, here is provided a computing device including processors configured to execute instructions and a memory storing the instructions, an execution of the instructions configures the processors to collect sensor data about components included in the computing device while the computing device is processing an allocated process, receive the sensor data about the components from the BMC and predict a failure occurrence for one or more components among the components based on the sensor data about the components, and migrate a process being processed by the computing device based on a prediction result of the failure occurrence for the one or more components.

In a general aspect, here is provided a processor-implemented method including collecting sensor data about components included in a computing device using a board management controller (BMC), predicting a failure occurrence for one or more components among the components based on the sensor data about the components, and detecting whether a failure has occurred for the one or more components among the components based on the sensor data about the components.

The predicting of the failure occurrence for the one or more components may include predicting the failure occurrence for the one or more components using a failure prediction module including a neural processing unit (NPU) for executing a prediction model and the prediction model may be a model trained to predict a failure for the one or more components among the components using the sensor data about the components as input.

The detecting whether a failure has occurred may include detecting the failure occurrence for the one or more components among the components using a failure detection module including an NPU for executing a detection model and the detection model may be a model trained to detect a failure for the one or more components using the sensor data about the components as input.

The method may include transmitting a prediction result of the failure occurrence for the one or more components to an external scheduler of the computing device or an internal scheduler of the computing device and the external scheduler of the computing device or the internal scheduler of the computing device may be configured to determine whether to migrate a process being processed by the computing device based on the prediction result of the failure occurrence for the one or more components.

The external scheduler of the computing device may be configured to determine whether to migrate the process being processed by the computing device to another computing device.

The predicting of the failure occurrence may include outputting a failure grade indicating severity of a failure, a probability of occurrence of a failure, and time at which a failure occurs, as a prediction result of the failure occurrence for the one or more components.

The method may include transmitting a detection result of the failure occurrence for the one or more components to an external scheduler of the computing device or an internal scheduler of the computing device and the external scheduler of the computing device or the internal scheduler of the computing device may be configured to restore or restart a process being processed, to a previous checkpoint, by the computing device.

In a general aspect, here is provided a non-transitory computer-readable storage medium storing instructions that, when executed by a processor, cause the processor to perform the method.

Other features and aspects will be apparent from the following detailed description, the drawings, and the claims.

### BRIEF DESCRIPTION OF THE DRAWINGS

FIG. 1 illustrates an example an electronic device according to one or more embodiments.

FIG. 2 illustrates an example method of operating a computing device according to one or more embodiments.

FIG. 3 illustrates an example method of failure detection of a computing device according to one or more embodiments.

FIG. 4 illustrates an examples method of failure prediction of a computing device according to one or more embodiments.

FIG. 5 illustrates an example process of failure prediction according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used in connection with various example embodiments of the disclosure, any use of the terms “module” or “unit” means processing hardware, e.g., configured to implement software and/or firmware to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software may include components such as software components, object-oriented software components, class components, and may include processor task components, processes, functions, attributes, procedures, subroutines, segments of the software. Software may further include program code, drivers, firmware, microcode, circuits, data, database, data structures, tables, arrays, and variables. In another non-limiting example, such software may be executed by one or more central processing units (CPUs) of an electronic device or secure multimedia card.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Computing devices intended for data centers and other high performance computing (HPC) systems and devices (e.g., supercomputers) may entail a need for high reliability. Supercomputers and other HPC systems may have a short mean time between failure (MTBF) for various reasons. The MTBF of a supercomputer may be short due to various reasons. That is, a supercomputer and other HPC systems have configurations that have become complicated and also require a large amount of power. The MTBF of supercomputers may be from as short as a few hours to as many as tens of hours. In other words, supercomputers and other HPC systems may have a failure within as short as a few hours to as many as tens of hours. A typical method of checkpointing/recovery can periodically back up and recover operation results in the case in which operations become impossible due to an occurrence of such a failure. However, this typical solution may be deficient as it may be a great waste of time and resources to back up and recover operation results every cycle, which, based on the above discussed MTBF timeline for supercomputers, is too short, where such failures may occur at any time. In an example, the detection and prediction of such failures may be desired.

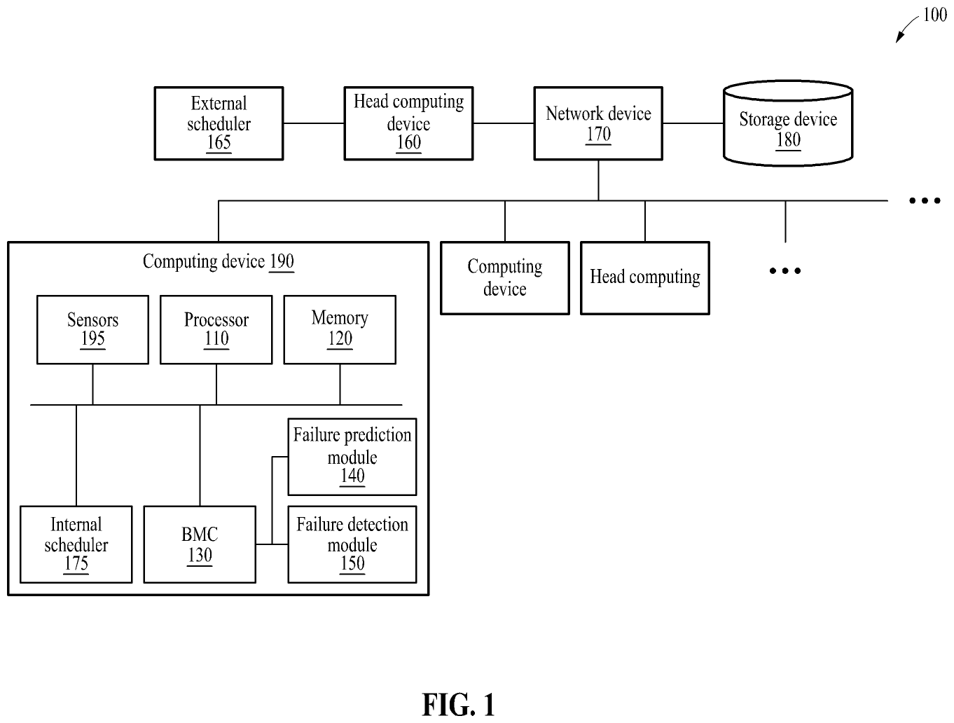

FIG. 1 illustrates an example an electronic device according to one or more embodiments.

Referring to FIG. 1, in a non-limiting example, an electronic apparatus 100 may be a computer that may perform large amounts of operations at a much higher speed than a general computer. In an example, the electronic device 100 may be a supercomputer or other HPC system. The electronic device 100 may include a plurality of computing devices, a head computing device 160, a network device 170, and a storage device 180. In an example, electronic device 100 may also include other components than the components illustrated in FIG. 1. In an example, the computing device 190 may include one or more sensors 195 and an internal scheduler 175 or be associated with an external scheduler 165. The external scheduler 165 may be included in the head computing device 160 of the electronic device 100.

In an example, the electronic device 100 may include a plurality of computing devices (e.g., computing devices 190). The computing device 190 in the electronic device 100 may be referred to as a server or node. The electronic device 100 may include hundreds to tens of thousands of computing devices 190. A plurality of computing devices 190 may communicate with each other through the network device 170 to solve large-scale issues.

The electronic device 100 may include the head computing device 160. The head computing device 160 may be referred to as a head server or head node. The head computing device 160 may perform as a scheduler for scheduling the plurality of computing devices 190. In an example, the head computing device 160 may include the external scheduler 165. The external scheduler 165 may be a hardware-configured scheduler or a software-configured scheduler included in the head computing device 160.

In an example, the supercomputer 100 may include the storage device 180. An operation result of the plurality of computing devices 190 may be stored by moving the operation results to the storage device 180 through the network device 170.

In an example, the computing device 190 may process a process assigned to solve large-scale issues. The computing device 190 may be a computing device including a processor 110, a memory 120, and a board management controller (BMC) 130. The processor 110, the memory 120, and the BMC 130 may communicate with each other through a bus, a network on a chip (NoC), peripheral component interconnect express (PCIe), or the like. In an example, while components related to the example described herein are illustrated in the computing device 190, the computing device 190 may also include other general-purpose components than the components illustrated in FIG. 1.

The memory 120 may include computer-readable instructions. The processor 110 may be configured to execute computer-readable instructions, such as those stored in the memory 120, and through execution of the computer-readable instructions, the processor 110 is configured to perform one or more, or any combination, of the operations and/or methods described herein. The memory 120 may be a volatile or nonvolatile memory. The memory 120 may be hardware for storing data processed and data to be processed by the computing device 190. In addition, the memory 120 may store an application, a driver, and the like to be driven by the computing device 190.

The processor 110 may be configured to execute programs or applications to configure the processor 110 to control the electronic device to perform one or more or all operations and/or methods involving the control of the computing device 190 and fault detection and prediction, and may include any one or a combination of two or more of, for example, a central processing unit (CPU), a graphic processing unit (GPU), a neural processing unit (NPU) and tensor processing units (TPUs), but is not limited to the above-described examples.

The processor 110 may be implemented as a central processing unit (CPU), a graphics processing unit (GPU), an application processor (AP), and the like that are included in the electronic device 100. However, examples are not limited thereto. That is, the computing device 190 may include a plurality of processors 110. The plurality of processors 110 may be configured in a method of a sharing memory system for sharing the memory 120. The plurality of processors 110 may be configured in a method of a distributed memory system in which each processor 110 includes an individual memory.

In an example, the computing device 190 may include the BMC 130. The BMC 130 may monitor states through communication with sensors 195 that may be installed in hardware (e.g., a processor, fan, power supply, etc.) included in the computing device 190. In an example, the sensors 195 may include one or more of electrical measurement devices (e.g., voltmeters and/or ammeters), temperature measuring devices (e.g., thermometers), humidity measurement devices, fan speed gauges, and/or ring oscillation measurement devices. However, the descriptions of the sensors 195 are not limited thereto. The BMC 130 may monitor the computing device 190 by collecting sensor data about (i.e., from or otherwise related to) the hardware included in the computing device 190. The BMC 130 may monitor states of the computing device 190 using various server management standards, such as an intelligent platform management interface (IPMI).

In an example, the BMC 130 may communicate with a failure prediction module 140 and a failure detection module 150. When the failure prediction module 140 receives sensor data as an input from the BMC 130, the failure prediction model 150 may predict an occurrence of a failure. The failure detection module 150 that has received the sensor data from the BMC 130 may detect the occurrence of a failure. The failure prediction module 140 and the failure detection module 150 may each include a neural processing unit (NPU). The NPU included in the failure prediction module 140 may perform failure prediction and the NPU included in the failure detection module 150 may perform failure detection.

The failure prediction module 140 and the failure detection module 150 may be configured as a single module. Since the failure prediction module 140 and the failure detection module 150 are configured as a single module, an NPU included in one module may perform both failure prediction and failure detection.

The BMC 130 and an NPU for failure prediction and failure detection may be implemented as a single chip.

Hereinafter, a method of predicting and detecting a failure occurrence is further described.

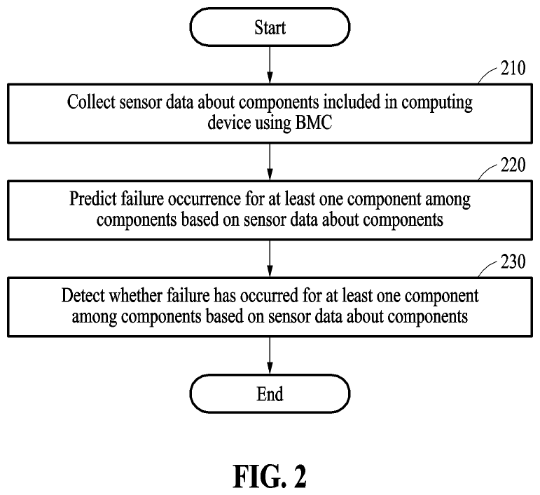

FIG. 2 illustrates an example method of operating a computing device according to one or more embodiments.

In the following examples, operations may be performed sequentially but not necessarily. In an example, the order of the operations may change and at least two of the operations may be performed in parallel. Operations shown in FIG. 2 may be performed by at least one component of a computing device (e.g., computing device 190).

Referring to FIG. 2, in a non-limiting example, in operation 210, a computing device (e.g., computing device 190) may collect sensor data from components included in the computing device (e.g., using a BMC).

The BMC may collect sensor data of hardware devices through sensors (e.g., sensors 195) arranged at various positions in the computing device.

In an example, the sensor data obtained by the sensors (e.g., sensors 195) may include hourly signal data and hourly log data. The hourly signal data may include a variety of information, such as voltage information, temperature information, fan speed information, humidity information, and ring oscillator information collected by time. The hourly log data may include a variety of information, such as memory log information (e.g., log information of a solid state drive (SSD)) and processor log information (e.g., log information of a GPU).

In operation 220, the computing device (e.g., computing device 190) may predict a failure occurrence for at least one component among the components based on the sensor data from the components.

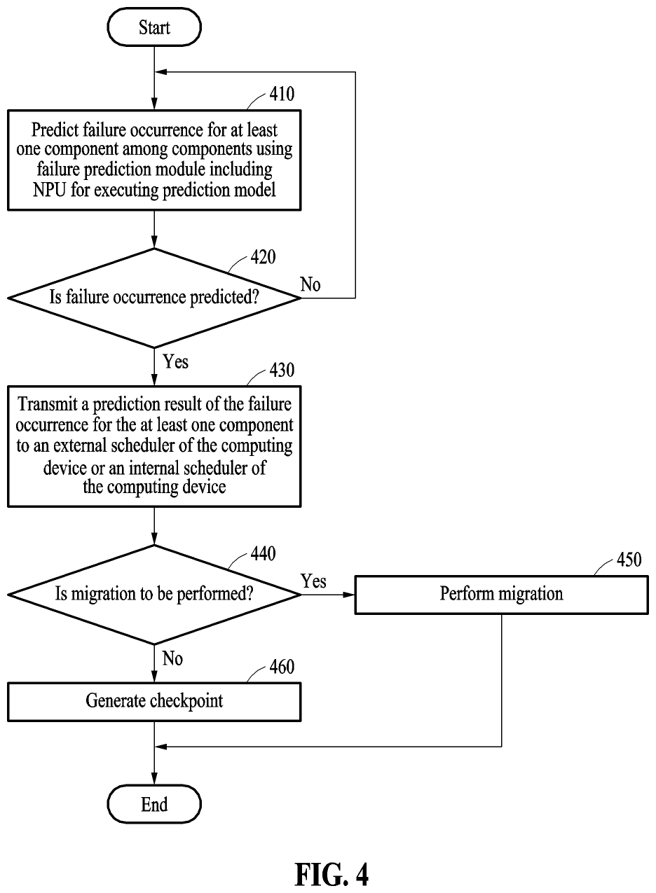

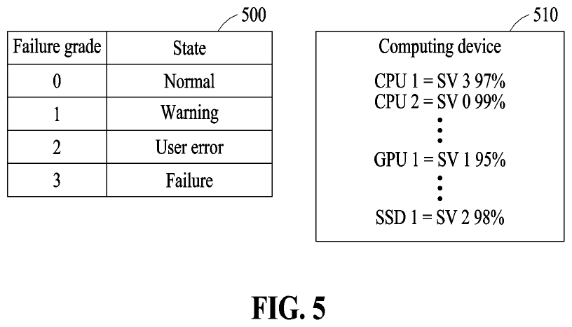

In an example, the computing device (e.g., computing device 190) may include a failure prediction module (e.g., failure prediction module 140). Using the failure prediction module, the computing device may predict the failure occurrence for the at least one component among the components based on the sensor data from the components. A method of predicting the failure occurrence using the failure prediction module by the computing device is described in greater detail below with respect to FIGS. 4 and 5.

In operation 230, the computing device (e.g., computing device 190) may detect whether a failure has occurred for the at least one component among the components based on the sensor data from the components.

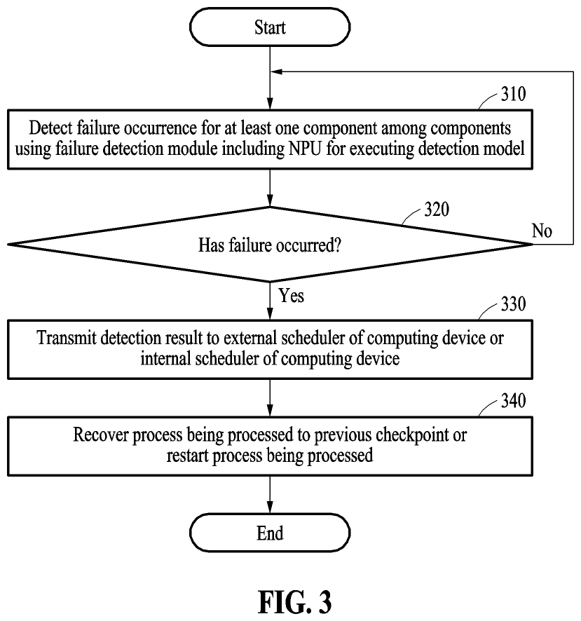

In an example, the computing device (e.g., computing device 190) may include a failure detection module (e.g., failure detection module 150). Using the failure detection module, the computing device may detect the failure occurrence for the at least one component among the components based on the sensor data from the components. A method of detecting the failure occurrence using the failure detection module by the computing device is further described below in greater detail with respect to FIG. 3.

FIG. 3 illustrates an example method of failure detection of a computing device according to one or more embodiments.

In the following examples, operations may be performed sequentially but not necessarily. In an example, the order of the operations may change and at least two of the operations may be performed in parallel. Operations shown in FIG. 3 may be performed by at least one component of a computing device (e.g., computing device 190).

Referring to FIG. 3, in a non-limiting example, in operation 310, a computing device (e.g., supercomputer 100) may detect a failure occurrence for one or more components among components using a failure detection module (e.g., failure detection module 150) including an NPU for executing a detection model.

In an example, the detection model may be a model for detecting a failure for one or more components among the components included in the computing device. Using sensor data from the components as input, the detection model may be a neural network model trained to detect a failure for the at least one component among the components. The failure detection model may be a model trained in various methods, such as a convolutional neural network (CNN) and a deep neural network (DNN). In an example, the components of the computing device may be upgraded. Because logs may be generated with new text, which has not been previously used, depending on the upgrade of the components and the meaning of a failure may be different for each new, or existing, component, an artificial intelligence (AI) model that has been trained on the details described above may be used as a detection model.

In an example, the detection model may use hourly signal data to identify one or more components that may be in an abnormal state that may not have been identified in existing sensor data (e.g., initial sensor data) and may determine that a failure has occurred for the identified components. The detection model may determine that a failure has occurred for the one or more components that are not included in a dynamic range in which the hourly signal data is determined to be normal. The dynamic range may be updated through over-the-air (OTA) functions and training or through other update methods.

In operation 320, the computing device (e.g., supercomputer 100) may determine whether a failure has occurred in the computing device. In other words, the computing device may determine whether a failure has occurred for one or more components among the components of the computing device.

When the computing device determines that a failure has not occurred, the computing device may perform operation 310 again after a predetermined period of time. In an example, the predetermined period of time may be 5 minutes. The computing device may perform operation 330 when the computing device determines that a failure has occurred.

In operation 330, the computing device (e.g., computing device 190) may transmit a detection result to an external scheduler (e.g., external scheduler 175) of the computing device or an internal scheduler of the computing device.

In an example, the external scheduler of the computing device may be a head computing device.

The computing device may transmit a failure occurrence to a user of a supercomputer or an external server using an Intelligent Platform Management Interface (IPMI) tool function.

In operation 340, the computing device (e.g., computing device 190) may recover a process being processed to a previous checkpoint or may restart the process being processed.

The external scheduler (e.g., external scheduler 165) or the internal scheduler (e.g., internal scheduler 175) may cause the computing device to restore the process being processed to the previous checkpoint. The computing device may restart the process from the previous checkpoint.

The external scheduler or the internal scheduler may cause the computing device to restart the process being processed. The computing device may restart the process from the beginning.

In an example, the computing device may query for a solution method for the failure on a generative AI model and may resolve the failure according to the solution method obtained from the AI model in response to the query.

The computing device may label sensor data and the detection result of the failure occurrence based on the sensor data. The computing device may train or update the detection model using the sensor data and the failure detection result labeled with the sensor data. Alternatively, the detection model may be updated through OTA.

FIG. 4 illustrates an example method of failure prediction of a computing device according to one or more embodiments.

In the following examples, operations may be performed sequentially but not necessarily. In an example, the order of the operations may change and at least two of the operations may be performed in parallel. Operations shown in FIG. 4 may be performed by at least one component of a computing device.

Referring to FIG. 4, in a non-limiting example, in operation 410, a computing device (e.g., computing device 190) may predict a failure occurrence for at least one component among components using a failure prediction module (e.g., failure prediction module 140) including an NPU for executing a prediction model.

The prediction model may be a model for predicting a failure for the at least one component among the components included in the computing device. Using sensor data from the components as an input, the prediction model may be a model trained to predict a failure for the one or more components among the components. The failure prediction model may be a model trained by various methods such as a CNN and a DNN.

In an example, the prediction model may be a model trained to predict a failure of a component based on a pattern of hourly log data and/or a pattern of hourly signal data.

In operation 420, the computing device (e.g., computing device 190) may determine whether the failure occurrence has been predicted. In other words, the computing device may determine whether the failure occurrence has been predicted for one or more components from among the components.

When the computing device determines that the failure occurrence has not been predicted, the computing device may perform operation 410 again after a predetermined period of time. In an example, the predetermined period of time may be 5 minutes. The computing device may perform operation 430 when the computing device determines that the failure occurrence has been predicted.

In operation 430, the computing device (e.g., computing device 190) may transmit a prediction result of the failure occurrence for the identified one or more components to an external scheduler (external scheduler 165) of the computing device or an internal scheduler (e.g., internal scheduler 175) of the computing device.

The external scheduler of the computing device may be a head computing device. The internal scheduler of the computing device may be a hardware-configured scheduler or a software-configured scheduler included in the computing device. In an example, the prediction result of the failure occurrence may include one or more of a failure grade, the probability of occurrence of a failure, and time at which a failure occurs.

The prediction result of the failure occurrence for the at least one component is further described below in greater detail with respect to FIG. 5.

In operation 440, the computing device (e.g., computing device 190) may determine whether to perform a migration.

The computing device may perform operation 450 when the computing device receives an instruction to perform migration from the external scheduler (external scheduler 165) or the internal scheduler (e.g., internal scheduler 175). The computing device may perform operation 460 when the computing device does not receive the instruction to perform migration from the external scheduler or the internal scheduler.

In an example, the external scheduler may cause the computing device to migrate a process being processed to another computing device. In an example, the external scheduler may cause the computing device that is predicted to fail or have a failure included in a supercomputer (e.g., electronic device 100) to migrate the process being processed by the computing device to another computing device included in the supercomputer. In other words, when the failure occurrence is predicted, the external scheduler may cause the computing device to migrate all processes being processed by the computing device to another computing device. The external scheduler may calculate the time required for migration and may cause the computing device to perform operation 460 when the time required for migration is longer than the prediction time for the failure occurrence. The external scheduler may cause the computing device to perform operation 450 when the time required for migration is shorter than the prediction time for the failure occurrence.

In an example, the internal scheduler may cause the computing device to migrate a process being processed by a component that is predicted to have a failure to another component when a failure is predicted to occur for any one of the components included in the computing device. In an example, the internal scheduler may cause the computing device to migrate a process being processed by a processor in which a failure is predicted to occur to another processor when a failure is predicted to occur for any one of a plurality of processors. In other words, the internal scheduler may cause the computing device to internally migrate the process being processed by the component that is predicted to fail or have a failure when a failure is predicted to occur. The internal scheduler may calculate the time required for migration and may cause the computing device to perform operation 460 when the time required for migration is longer than the prediction time for the failure occurrence. The internal scheduler may cause the computing device to perform operation 450 when the time required for migration is shorter than the prediction time for the failure occurrence.

In operation 450, the computing device (e.g., computing device 190) may perform migration according to the instruction of the external scheduler (external scheduler 165) or the internal scheduler (e.g., internal scheduler 175). A method of performing the migration is described above and thus, the description thereof is omitted.

In operation 460, the computing device (e.g., computing device 190) may generate a checkpoint according to the instruction of the external scheduler (external scheduler 165) or the internal scheduler (e.g., internal scheduler 175). In other words, the computing device may store the process being processed in case of the failure occurrence according to the instruction of the external scheduler or the internal scheduler. Therefore, when a failure actually occurs later, the computing device may continue processing the process from the previously generated checkpoint without having to restart the process from the beginning.

In an example, the computing device may label sensor data and the prediction result of the failure occurrence of the sensor data. The computing device may train or update the prediction model using the sensor data and the prediction result of the failure occurrence labeled with the sensor data. The prediction model may be updated through OTA.

FIG. 5 illustrates an example process of failure prediction according to one or more embodiments.

Referring to FIG. 5, in a non-limiting example, prediction results and failure grades of a failure occurrence for a computing device included in a supercomputer are illustrated.

A prediction result of a computing device 510 predicted by a prediction model may include a failure grade 500 and an output of the probability of a failure occurrence. In an example, referring to the computing device 510, CPU 1 may be represented as 97% in SV 3. SV 3 may indicate failure grade 3 and 97% may indicate a confidence value.

The failure grade 500 included in the computing device 510 may indicate the severity of a failure. In an example, the failure grade 500 may be classified into four grades. Grade 0 may indicate a normal state, grade 1 may indicate a warning, grade 2 may indicate a user error, and grade 3 may indicate a failure. Grade 0 may indicate a normal state in which a component is normally operating. Grade 1 may indicate a warning about the operation of the computing device. Grade 2 may indicate a user error indicating that an error is not due to a component failure in the computing device. Grade 3 may indicate a failure indicating that a failure has occurred in a component of the computing device. However, the above-described classification of the failure grade 500 is only an example, and examples are not limited thereto.

When a failure has occurred in a component of the computing device (e.g., computing device 190), there may be disruptions to services and operations using a supercomputer (e.g., electronic device 100). Therefore, the computing device 510 may determine grade 3 to be the case where a failure is predicted to occur.

However, even if the failure grade is grade 3, the computing device 510 may not predict the failure occurrence when a reliability value is low. In an example, it is supposed that CPU 3 of the computing device 510 has failure grade 3 and a reliability value of 20%. The failure grade of CPU 3 is high with grade 3, but since the reliability value is 20% indicating the probability that the computing device 510 has a failure once out of five times, the computing device 510 may predict that the failure will not occur in CPU 3.

In other words, the computing device 510 may predict that a failure will occur for a component, when the failure grade for the component is above a threshold grade and the confidence value is above a threshold rate.

The neural networks, processors, memories, electronic devices, computing devices, electronic apparatus 100, processor 110, memory 120, BMC 130, failure prediction module 140, failure detection module 150, head computing device 160, external scheduler 165, network device 170, storage device 180, internal scheduler 175, sensors 190, and computing device 510 described herein and disclosed herein described with respect to FIGS. 1-5 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A computing device, comprising:
processors configured to execute instructions; and
a memory storing the instructions, wherein execution of the instructions configures the processors to:
collect sensor data about components included in the computing device while the computing device is processing an allocated process;
receive the sensor data about the components from the BMC and predict a failure occurrence one or more components among the components based on the sensor data about the components; and receive the sensor data about the components from the BMC and detect whether a failure has occurred for the one or more components among the components based on the sensor data about the components.

2. The computing device of claim 1, receiving the sensor data comprises executing a prediction model though a neural processing unit (NPU) for predicting a failure for the one or more components using the sensor data about the components as input.

3. The computing device of claim 1, wherein the receiving the sensor data comprises detecting a failure though a neural processing unit (NPU) for the one or more components using the sensor data about the components as input.

4. The computing device of claim 1, wherein the processors are configured to transmit a prediction result of the failure occurrence for the one or more components to an external scheduler of the computing device or for internal scheduling by the processors, and
wherein the external scheduler of the computing device or the internal scheduling is configured to determine whether to migrate a process being processed by the computing device based on the prediction result of the failure occurrence for the one or more components.

5. The computing device of claim 4, wherein the external scheduler of the computing device is configured to determine whether to migrate the process being processed by the computing device to another computing device.

6. The computing device of claim 1, wherein the receiving the sensor data comprises outputting a failure grade indicating severity of a failure, a probability of occurrence of a failure, and time at which a failure occurs, as a prediction result of the failure occurrence for the one or more components.

7. The computing device of claim 1, wherein the processors are configured to transmit a detection result of the failure occurrence for the one or more components among the components to an external scheduler of the computing device or for internal scheduling by the processors, and
wherein the external scheduler of the computing device or the internal scheduling is configured to restore or restart a process being processed, to a previous checkpoint, by the processors.

8. A computing device, comprising:
processors configured to execute instructions; and
a memory storing the instructions, wherein execution of the instructions configures the processors to:
collect sensor data about components included in the computing device while the computing device is processing an allocated process;
receive the sensor data about the components from the BMC and predict a failure occurrence for one or more components among the components based on the sensor data about the components; and
migrate a process being processed by the computing device based on a prediction result of the failure occurrence for the one or more components.

9. A processor-implemented method, the method comprising:
collecting sensor data about components included in a computing device using a board management controller (BMC);
predicting a failure occurrence for one or more components among the components based on the sensor data about the components; and
detecting whether a failure has occurred for the one or more components among the components based on the sensor data about the components.

10. The method of claim 9, wherein the predicting of the failure occurrence for the one or more components comprises predicting the failure occurrence for the one or more components using a failure prediction module including a neural processing unit (NPU) for executing a prediction model, and
wherein the prediction model is a model trained to predict a failure for the one or more components among the components using the sensor data about the components as input.

11. The method of claim 9, wherein the detecting whether a failure has occurred comprises detecting the failure occurrence for the one or more components among the components using a failure detection module including an NPU for executing a detection model, and
wherein the detection model is a model trained to detect a failure for the one or more components using the sensor data about the components as input.

12. The method of claim 9, further comprising:
transmitting a prediction result of the failure occurrence for the one or more components to an external scheduler of the computing device or an internal scheduler of the computing device,
wherein the external scheduler of the computing device or the internal scheduler of the computing device is configured to determine whether to migrate a process being processed by the computing device based on the prediction result of the failure occurrence for the one or more components.

13. The method of claim 12, wherein the external scheduler of the computing device is configured to determine whether to migrate the process being processed by the computing device to another computing device.

14. The method of claim 9, wherein the predicting of the failure occurrence comprises outputting a failure grade indicating severity of a failure, a probability of occurrence of a failure, and time at which a failure occurs, as a prediction result of the failure occurrence for the one or more components.

15. The method of claim 9, further comprising:
transmitting a detection result of the failure occurrence for the one or more components to an external scheduler of the computing device or an internal scheduler of the computing device,
wherein the external scheduler of the computing device or the internal scheduler of the computing device is configured to restore or restart a process being processed, to a previous checkpoint, by the computing device.

16. A non-transitory computer-readable storage medium storing instructions that, when executed by a processor, cause the processor to perform the method of claim 9.
